(19) United States
(12) Patent Application Publication
(10) Pub. No.: US 2021/0171391 A1
(43) Pub. Date: Jun. 10, 2021

(54) WINDOW MANUFACTURING METHOD

(71) Applicant: Samsung Display Co., Ltd., Yongin-Si (KR)

(72) Inventors: Yuri KIM, Guri-si (KR); WOOSUK SEO, Yongin-si (KR); MINKI KIM, Hwaseong-si (KR); Byeong-Beom KIM, Asan-si (KR); Hoikwan LEE, Suwon-si (KR)

(21) Appl. No.: 16/940,819

(22) Filed: Jul. 28, 2020

(30) Foreign Application Priority Data
Dec. 10, 2019 (KR) 10-2019-0164043

(51) Int. Cl. C03C 15/00; C03C 21/00; C03C 23/00

(52) U.S. Cl. CPC C03C 15/00; C03C 23/0075; C03C 21/002

(57) ABSTRACT

A method for manufacturing the window includes providing an initial window having a first compressive stress value and cleaning the initial window to provide a window having a second compressive stress value. The cleaning of the initial window includes acid cleaning the initial window by using acid, and alkali cleaning the initial window by using alkali after the acid cleaning. A linear relational expression is modeled between a difference between the first and second compressive stress values and a temperature and a holding time in the acid cleaning.

This application claims priority to Korean Patent Application No. 10-2019-0164043, filed on Dec. 10, 2019, and all the benefits accruing therefrom under 35 U.S.C. § 119, the content of which in its entirety is herein incorporated by reference.

### BACKGROUND

Embodiments of the invention relate to a window manufacturing method, and more particularly, to a method for manufacturing a window, which includes a cleaning process.

An electronic apparatus includes a window, a housing, and electronic elements. The electronic elements include various elements that are activated according to an electrical signal such as a display element, a touch element, or a detection element.

The window protects the electronic elements and provides an active area to a user. Thus, the user may provide an input to the electronic elements or receive information generated in the electronic elements through the window. In addition, the electronic elements may be stably protected against external impacts through the window.

### SUMMARY

Due to a trend of slimming of an electronic apparatus, lightweight and thinning of a window are also required. Thus, to compensate for the structural vulnerability, a method for manufacturing the window having excellent strength and surface durability has been studied.

Embodiments of the invention provide a method for manufacturing a window that is improved in compressive stress characteristic and impact strength by optimizing a cleaning process.

Embodiments of the invention also provide a method for manufacturing a window, which is capable of easily controlling a cleaning process by proposing a relationship between variations in a cleaning amount depending on process conditions of the cleaning process.

An embodiment of the inventive concept provides a method for manufacturing a window, the method including providing an initial window having a first compressive stress value, and cleaning the initial window to provide a window having a second compressive stress value, where the cleaning of the initial window includes acid cleaning the initial window by using acid, and alkali cleaning the initial window by using alkali after the acid cleaning, where a difference between the first compressive stress value and the second compressive stress value satisfies following Equations 1 and 2:

ΔCS(MPa)=δ·t(min)+θ, [Equation 1]

ΔCS(MPa)=α·T(° C.)+β, [Equation 2]

where, in Equation 1, a following relational expression is satisfied: 0<δ≤10, and −300≤θ<0, in Equation 2, a following relational expression is satisfied: 0<α<10, and 0<β≤50 , and in Equations 1 and 2, ΔCS is an absolute value of the difference between the first compressive stress value and the second compressive stress value, T is a temperature in the acid cleaning, and t is a holding time of the acid cleaning, and in Equations 1 and 2, words in parentheses represent following units of corresponding parameters: a unit of ACS is megapascals (MPa), and a unit of T is degrees Celsius (° C.), and a unit of t is minutes (min).

In an embodiment, the temperature T in the acid cleaning of the Equation 2 may range of about 40° C. to about 70° C.

In an embodiment, the holding time t in the acid cleaning of the Equation 1 may range of about 1 minutes to about 20 minutes.

In an embodiment, the difference between the first compressive stress value and the second compressive stress value may satisfy following Equation 3:

ΔCS(MPa)=ν·T(° C.)+ω·t(min)+γ, [Equation 3]

where, in Equation 3, a following relational expression is satisfied: 0<ν≤10, 0<ω≤20, and −150≤γ≤−50.

In an embodiment, the difference between the first compressive stress value and the second compressive stress value may satisfy following Equation 3-1:

ΔCS(MPa)=4T(° C.)+2t(min)+γ. [Equation 3-1]

In an embodiment, the difference between the first compressive stress value and the second compressive stress value may be proportional to a cleaning amount in the acid cleaning, and the cleaning amount may be a removal amount per a unit area of the initial window, which is removed from a surface of the initial window.

In an embodiment, the cleaning amount may satisfy following Equations 4 and 5:

L_{AB}(mg/cm²)=δ′·t(min)+θ′ , [Equation 4]

L_{AB} (mg/cm²)=α′·T(° C.)+β′, [Equation 5]

where, in Equation 4, a following relational expression is satisfied: 0<δ′≤5, and −300≤θ′<0, in Equation 5, a following relational expression is satisfied: 0<α′≤0.05, and 0<β′≤0.5, and in Equations 4 and 5, L_{AB} is a cleaning amount, and mg/cm² in parentheses represent a unit of L_{AB}: milligrams per square centimeter.

In an embodiment, the cleaning amount may satisfy following Equation 6:

L_{AB}(mg/cm²)=ν·T(° C.)+ω·t(min)+γ′, [Equation 6]

wherein, in Equation 6, a following relational expression is satisfied: 0<ν′≤0.05, 0<ω′≤0.1, and −50≤γ′<0.

In an embodiment, the cleaning amount may satisfy following Equation 6-1:

L_{AB} (mg/cm²)=0.01T(° C.)+0.02t(min)+γ′ [Equation 6-1]

In an embodiment, the cleaning amount may be a sum of a first cleaning amount in the acid cleaning and a second cleaning amount in the alkali cleaning, the first cleaning amount may range of about 30 percent by weight (wt %) to about 40 wt % based on a total weight of the cleaning amount, and the second cleaning amount may range of about 60 wt % to about 70 wt % based on the total weight of the cleaning amount.

In an embodiment, the providing of the initial window may include providing a base glass, and toughening the provided base glass, wherein the base glass may include lithium alumino-silicate (“LAS”)-based glass or sodium alumino-silicate (“NAS”)-based glass.

In an embodiment, the toughening of the base glass may include chemically toughening of the base glass by using toughening molten salt containing at least one of KNO₃ or NaNO₃.

In an embodiment, the toughening of the base glass may be performed at a temperature of about 350° C. to about 450° C.

In an embodiment, the acid cleaning may include providing an acid cleaning solution containing at least one of a nitric acid (HNO₃), a sulfuric acid (H₂SO₄), or a hydrochloric acid (HCl).

In an embodiment, the alkali cleaning may include providing an alkali cleaning solution containing at least one of a sodium hydroxide (NaOH) or potassium hydroxide (KOH).

In an embodiment of the inventive concept, a method for manufacturing a window includes providing an initial window that is chemically toughened, acid cleaning the initial window by using an acid cleaning solution to provide an intermediate window, and alkali cleaning the intermediate window by using an alkali cleaning solution to provide a final window, where a first compressive stress value of the initial window and a second compressive stress value of the final window satisfy following Equations 1 and 2:

ΔCS(MPa)=δ·t(min)+θ, [Equation 1]

ΔCS(MPa)=α·T(°C)+β, [Equation 2]

where, in Equations 1 and 2, ΔCS is an absolute value of a difference between the first compressive stress value and the second compressive stress value, and words in parentheses represent following units of corresponding parameters: a unit of ΔCS is megapascals (MPa), and a unit of T is degrees Celsius (° C.), and a unit of t is minutes (min), in Equation 1, a following relational expression is satisfied: 0<δ≤10, −300≤θ<0, and 1 minute≤t≤20 minutes, in Equation 2, and a following relational expression is satisfied: 0<α≤10, 0<β≤50, and 40° C.≤T≤70° C.

In an embodiment the intermediate window may include a void defined by eluting an alkali metal from the initial window.

In an embodiment, the intermediate window may include a base layer in which a ratio of silicon content to the alkali metal is substantially the same as a ratio of the silicon content to the alkali metal in the initial window, and an intermediate layer which is formed on a surface of the base layer and of which a ratio of the silicon content to the alkali metal ions is greater than the ratio of the silicon content to the alkali metal ions in the base layer.

In an embodiment, a ratio of the void in the intermediate layer may be greater than a ratio of the void in the base layer.

In an embodiment, the initial window may have a thickness of about 500 micrometers (μm) to about 800 μm, and the intermediate layer may have a thickness of about 0.2 μm to about 0.5 μm.

In an embodiment, the final window may be formed by removing the intermediate layer from the intermediate window.

In an embodiment, an absolute value of a difference between the first compressive stress value and the second compressive stress value may be proportional to a cleaning amount, and the cleaning amount may be a difference in weight between the initial window and the final window.

In an embodiment, the cleaning amount may satisfy following Equations 4 and 5:

L_{AB}(mg/cm²)=δ′·t(min)+θ′ , [Equation 4]

L_{AB}(mg/cm²)=α′·T(° C.)+β′, [Equation 5]

where, in Equation 4, a following relational expression is satisfied: 0<δ≤5, and −300≤θ′<0, in Equation 5, a following relational expression is satisfied: 0<α′≤0.05, and 0<β≤0.5, and in Equations 4 and 5, L_{AB} is the cleaning amount, and mg/cm² in parentheses represent a unit of L_{AB}: milligrams per square centimeter.

In an embodiment, the difference between the first compressive stress value and the second compressive stress value may satisfy following Equation 3-1:

ΔCS(MPa)=4T(° C.)+2t(min)+γ. [Equation 3-1]

### BRIEF DESCRIPTION OF THE FIGURES

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1 is a perspective view of an electronic apparatus according to an embodiment of the inventive concept;

FIG. 2 is an exploded perspective view of an electronic apparatus of FIG. 1;

FIG. 3 is a perspective view of a window according to an embodiment of the inventive concept;

FIG. 4 is a cross-sectional view of the window according to an embodiment of the inventive concept;

FIG. 5 is a flowchart illustrating a method for manufacturing a window according to an embodiment of the inventive concept;

FIG. 6 is a flowchart illustrating a method for manufacturing a window according to an embodiment of the inventive concept;

FIGS. 7A to 7G are schematic cross-sectional views illustrating a method for manufacturing a window according to an embodiment of the inventive concept;

FIG. 8A is a graph illustrating a variation in a cleaning amount depending on a process temperature in an acid cleaning process;

FIG. 8B is a graph illustrating a variation in a cleaning amount depending on a process temperature in an alkali cleaning process;

FIG. 9 is a graph illustrating a relationship between variations in a cleaning amount and a compressive stress value.

FIG. 10 is a graph illustrating results obtained by comparing strength of the window before and after the cleaning process;

FIG. 11 is a graph illustrating results obtained by comparing failure strength of the window before and after the cleaning process;

FIG. 12 is a graph illustrating a relationship between a vibration in the compressive stress value and strength of the window;

FIG. 13 is a graph illustrating a variation in a compressive stress value depending on a process temperature and a process maintenance time in an acid treatment process;

FIGS. 14A and 14B are graphs illustrating a relationship between variations in a compressive stress value depending on the process maintenance time in the acid treatment process;

FIG. 15 is a graph illustrating a relationship between variations in the compressive stress value depending on the process temperature in the acid treatment process;

FIG. 16 is a graph illustrating a variation in a cleaning amount depending on the process temperature and the process maintenance time in the acid treatment process;

FIG. 17 is a graph illustrating a relationship between variations in the cleaning amount depending on the process maintenance time in the acid treatment process; and

FIG. 18 is a graph illustrating a relationship between variations in the cleaning amount depending on a change of the process temperature in the acid treatment process.

### DETAILED DESCRIPTION

Since the present disclosure may have diverse modified embodiments, specific embodiments are illustrated in the drawings and are described in the detailed description of the inventive concept. However, this does not limit the present disclosure within specific embodiments and it should be understood that the present disclosure covers all the modifications, equivalents, and replacements within the idea and technical scope of the present disclosure.

In this specification, it will also be understood that when one component (or region, layer, portion) is referred to as being ‘on’, ‘connected to’, or ‘coupled to’ another component, it can be directly disposed/connected/coupled on/to the one component, or an intervening third component may also be present.

In this specification, “directly disposed” may mean that there is no layer, film, region, plate, or the like between a portion of the layer, the layer, the region, the plate, or the like and the other portion. For example, “directly disposed” may mean being disposed without using an additional member such and an adhesive member between two layers or two members.

Like reference numerals refer to like elements throughout. Also, in the figures, the thickness, ratio, and dimensions of components are exaggerated for clarity of illustration.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “At least one” is not to be construed as limiting “a” or “an.” “Or” means “and/or.” The term “and/or” includes any and all combinations of one or more of the associated listed items.

It will be understood that although the terms such as ‘first’ and ‘second’ are used herein to describe various elements, these elements should not be limited by these terms. The terms are only used to distinguish one component from other components. For example, a first element referred to as a first element in one embodiment can be referred to as a second element in another embodiment without departing from the scope of the appended claims. The terms of a singular form may include plural forms unless referred to the contrary.

Also, “under”, “below”, “above”, “upper”, and the like are used for explaining relation association of components illustrated in the drawings. The terms may be a relative concept and described based on directions expressed in the drawings. In this specification, the term “disposed on” may refer to a case in which it is disposed on a lower portion as well as an upper portion of any one member.

Unless otherwise defined, all terms (including technical and scientific terms) used herein have the same meaning as commonly understood by a person of ordinary skill in the art to which this invention belongs. Also, terms such as defined terms in commonly used dictionaries are to be interpreted as having meanings consistent with meaning in the context of the relevant art and are expressly defined herein unless interpreted in an ideal or overly formal sense.

The meaning of “include” or “comprise” specifies a property, a fixed number, a step, an operation, an element, a component or a combination thereof, but does not exclude other properties, fixed numbers, steps, operations, elements, components or combinations thereof

Hereinafter, a method for manufacturing a window according to an embodiment of the inventive concept will be described with reference to the accompanying drawings.

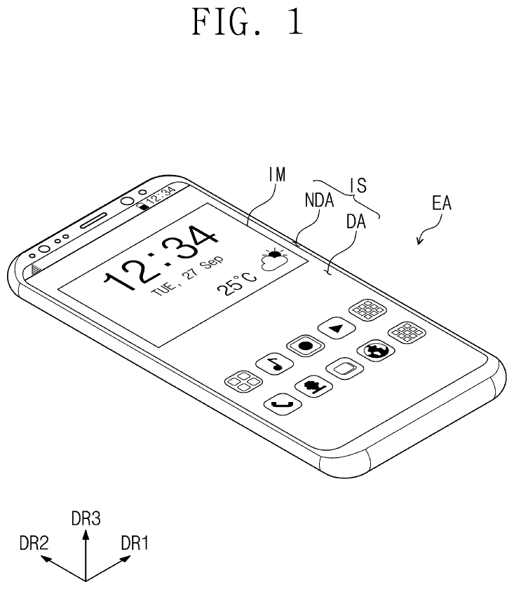

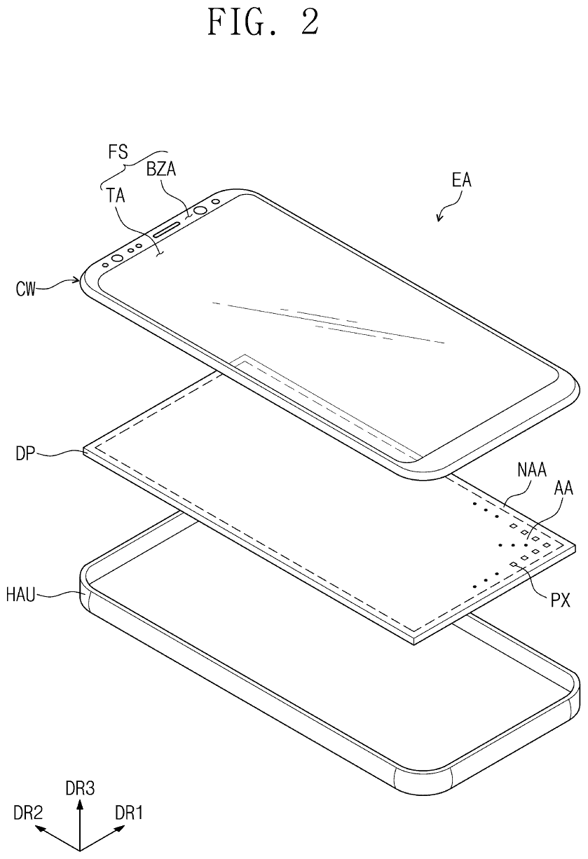

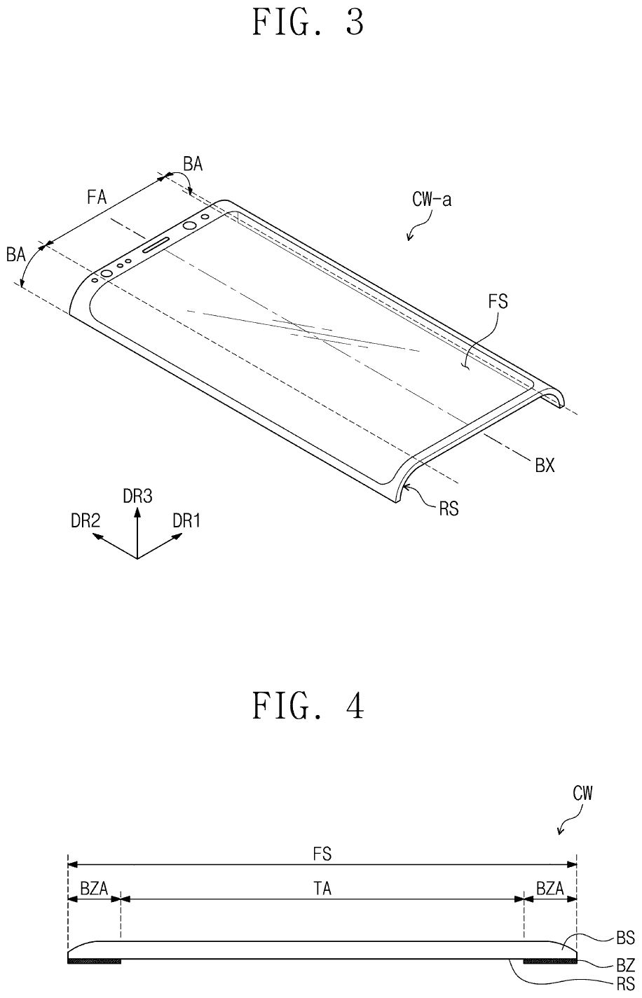

Hereinafter, exemplary embodiments of the inventive concept will be described with reference to the accompanying drawings. FIG. 1 is a perspective view of an electronic apparatus. FIG. 1 is a view illustrating an example of an electronic apparatus including a window manufactured through a method for manufacturing the window according to an embodiment of the inventive concept. FIG. 2 is an exploded perspective view of the electronic apparatus of FIG. 1. FIG. 3 is a perspective view of a window according to an embodiment of the inventive concept. FIG. 4 is a cross-sectional view of the window according to an embodiment of the inventive concept.

An electronic apparatus EA may be an apparatus that is activated according to an electrical signal. The electronic apparatus EA may include various examples. For example, the electronic apparatus EA may include a tablet, a notebook, a computer, a smart television, and the like. Hereinafter, an electronic apparatus EA including a smart phone will be described as an example.

The electronic apparatus EA may display an image IM in a third directional axis DR3 on a display surface IS parallel to a plane defined by first and second directional axes DR1 and DR2. The display surface IS on which the image IM is displayed may correspond to a front surface of the electronic apparatus EA and also correspond to a front surface FS of a window CW. In addition, the electronic apparatus EA may have a solid shape having a predetermined thickness in a third direction that is perpendicular to the plane defined by the first directional axis DR1 and the second directional axis DR2.

In the electronic apparatus EA of FIG. 1 according to an embodiment, the display surface IS may include a display area DA and a non-display area NDA adjacent to the display area DA. Although the non-display area NDA is illustrated as being disposed to surround the display area DA, the embodiment of the inventive concept is not limited thereto. The display area DA on which the image IM is displayed may be a portion corresponding to an active area AA of an electronic panel DP. The image IM may include a still image as well as a dynamic image. In FIG. 1, an interne search window is illustrated as an example of the image IM.

In this embodiment, the front surface (i.e., a top surface) or a rear surface (i.e., a bottom surface) of each of members may be defined based on a direction in which the image IM is displayed. Here, the image IM is displayed on the front surface. The front and rear surfaces may be opposite to each other in the third directional axis DR3. A normal direction of each of the front and rear surfaces may be parallel to the third directional axis DR3. The directions indicated as the first to third directional axes DR1, DR2, and DR3 may be relative concepts and thus changed into different directions on a condition that the relative positions of the first to third directional axes DR1, DR2, and DR3 are kept. Hereinafter, the first to third directions correspond to directions indicated by the first to third directional axes DR1, DR2, and DR3 and are designated by the same reference numerals, respectively.

The electronic apparatus EA includes a window CW, an electronic panel DP, and a housing HAU. In the electronic apparatus EA of FIGS. 1 and 2 according to an embodiment, the window CW and the housing HAU may be coupled to each other to define an outer appearance of the electronic apparatus EA.

The front surface FS of the window CW may define a front surface of the electronic apparatus EA as described above. The front surface FS of the window CW may include a transmission area TA and a bezel area BZA.

The transmission area TA may be an optically transparent area. For example, the transmission area TA may be an area having a visible light transmittance of about 90 percent (%) or more.

The bezel area BZA may be an area having a light transmittance that is relatively less than that of the transmission area TA. The bezel area BZA defines a shape of the transmission area TA. The bezel area BZA may be disposed adjacent to the transmission area TA to surround the transmission area TA.

The bezel area BZA may have a predetermined color. The bezel area BZA may cover the peripheral area NAA of the electronic panel DP to prevent the peripheral area NAA from being visible from the outside. However, this is merely an example. For example, in the window CW according to another embodiment of the inventive concept, the bezel area BZA may be omitted.

In an embodiment, the window CW may be a toughened glass substrate with a toughened treatment. The window CW may provide the transmission area TA by using a light transmittance of glass and may have a toughened surface to stably protect the electronic panel DP from an external impact.

The window CW may be manufactured through the method for manufacturing the window according to an embodiment. The window manufacturing method of an embodiment includes providing an initial window and cleaning the provided initial window, and the initial window may include a chemically toughened glass substrate. In the method for manufacturing the window according to an embodiment, a cleaning process may include an acid cleaning process and an alkali cleaning process, which are sequentially performed in that order. In the method for manufacturing the window according to an embodiment, process conditions in the cleaning process and a change in a compressive stress value of the window before and after the cleaning may satisfy a linear relational expression. Thus, the cleaning process may be controlled by easily deriving the process conditions in the cleaning process in consideration of mechanical properties of the finally required window by using the linear relational expression proposed by an embodiment. Detailed description of the method for manufacturing the window according to the embodiment will be described later.

The electronic panel DP may be activated according to an electrical signal. In this embodiment, the electronic panel DP is activated to display the image IM on the display surface IS of the electronic apparatus EA. The image IM may be provided visible to a user through the transmission area TA, and the user may receive information through the image IM. However, this is illustratively illustrated, and the electronic panel DP may be activated to sense an external input applied to the front surface in another embodiment. For example, the external input may include a user's touch, contact or adjacency of an object, a pressure, light, or heat and is not limited to a specific embodiment.

The electronic panel DP may include an active area AA and a peripheral area NAA. The active area AA may be an area that provides the image IM. The transmission area TA may overlap at least a portion of the active area AA in the third direction DR3 (i.e., a plan view).

The peripheral area NAA may be an area covered by the bezel area BZA. The peripheral area NAA is adjacent to the active area AA. The peripheral area NAA may surround the active area AA. A driving circuit or a driving line for driving the active area AA may be disposed on the peripheral area NAA.

The electronic panel DP may include a plurality of pixels PX. The pixels PX emit light in response to an electrical signal. The light emitted by the pixels PX implements the image IM. The pixel PX may include a display element. For example, the display element may be an organic light emitting element, a quantum dot light emitting element, a liquid crystal capacitor, an electrophoretic element, or an electrowetting element.

The housing HAU may be disposed under the electronic panel DP. The housing HAU may include a material having relatively high rigidity. For example, the housing HAU may include a plurality of frames and/or plates made of or including glass, plastic, or a metal. The housing HAU provides a predetermined accommodation space. The electronic panel DP may be accommodated in the accommodation space of the housing HAU and protected from an external impact.

FIG. 3 is a perspective view of a window CW-a according to an embodiment of the inventive concept. Compared to the window CW of FIG. 2, the window CW-a of FIG. 3 according to an embodiment may include a bent portion BA bent with respect to a bending axis BX. In an embodiment, the window CW-a may include a flat portion FA and the bent portion BA.

In an embodiment, the bending axis BX may extend in the second directional axis DR2 and may be provided on the rear surface RS of the window CW-a. The flat portion FA may be a portion parallel to the plane defined by the first directional axis DR1 and the second directional axis DR2. The bent portion BA may be a curved portion having a curved shape, which is adjacent to the flat portion FA. For example, referring to FIG. 3, the bent portion BA may be a portion that is adjacent to each of both long sides of the flat portion FA and may be a portion that is bent downward from the flat portion FA. However, the embodiment is not limited thereto. For example, the bent portion BA may be disposed adjacent to only one side of the flat portion FA or may be disposed adjacent to all four sides of the flat portion FA on the plane.

The shape of the window manufactured by the method for manufacturing the window according to an embodiment is not limited to that illustrated in each of FIGS. 2 and 3. For example, the window may be a foldable window that is switched between a folded state or an unfolded state with respect to the folding axis. That is, the method for manufacturing the window according to an embodiment, which will be described below, may be used for manufacturing windows having various shapes.

FIG. 4 is a cross-sectional view of a window CW according to an embodiment of the inventive concept. The window CW according to an embodiment may include a toughened glass substrate BS and a bezel layer BZ. The toughened glass substrate BS may be optically transparent. In this specification, the toughened glass substrate BS may be provided by performing a process of toughening base glass and a process of cleaning the toughened base glass according to the method for manufacturing the window, which will be described later.

The front surface FS of the toughened glass substrate BS is exposed to the outside of the electronic apparatus EA and defines the front surface FS of the window CW and the front surface of the electronic apparatus EA. The rear surface RS of the toughened glass substrate BS faces the front surface FS in the third directional axis direction DR3.

The bezel layer BZ is disposed on the rear surface RS of the toughened glass substrate BS to define the bezel area BZA. The bezel layer BZ has a relatively low light transmittance compared to the toughened glass substrate BS. For example, the bezel layer BZ may have a predetermined color. The bezel layer BZ may selectively transmit/reflect only light having a specific color. Alternatively, for example, the bezel layer BZ may be a light blocking layer that absorbs incident light. A color of the bezel area BZA may be determined according to the light transmittance of the bezel layer BZ.

The bezel layer BZ may be formed on the rear surface RS of the toughened glass substrate BS through printing or deposition. Here, the bezel layer BZ may be directly formed on the rear surface RS of the toughened glass substrate BS. Alternatively, the bezel layer BZ may be coupled to the rear surface RS of the toughened glass substrate BS through a separate adhesive member or the like. Here, the adhesive member may contact the rear surface RS of the toughened glass substrate BS.

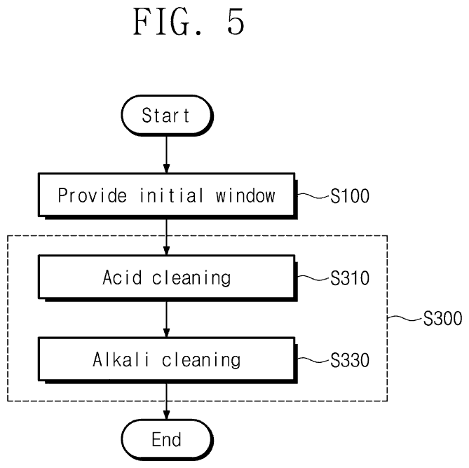

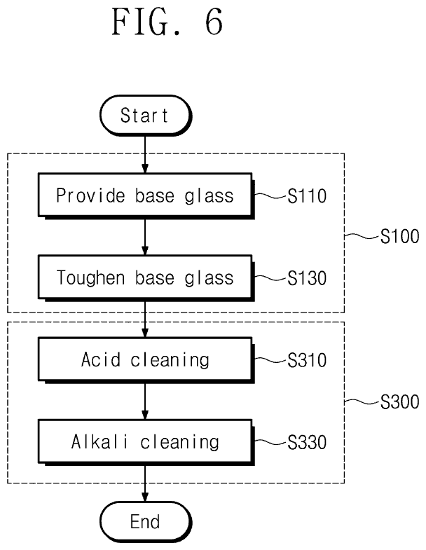

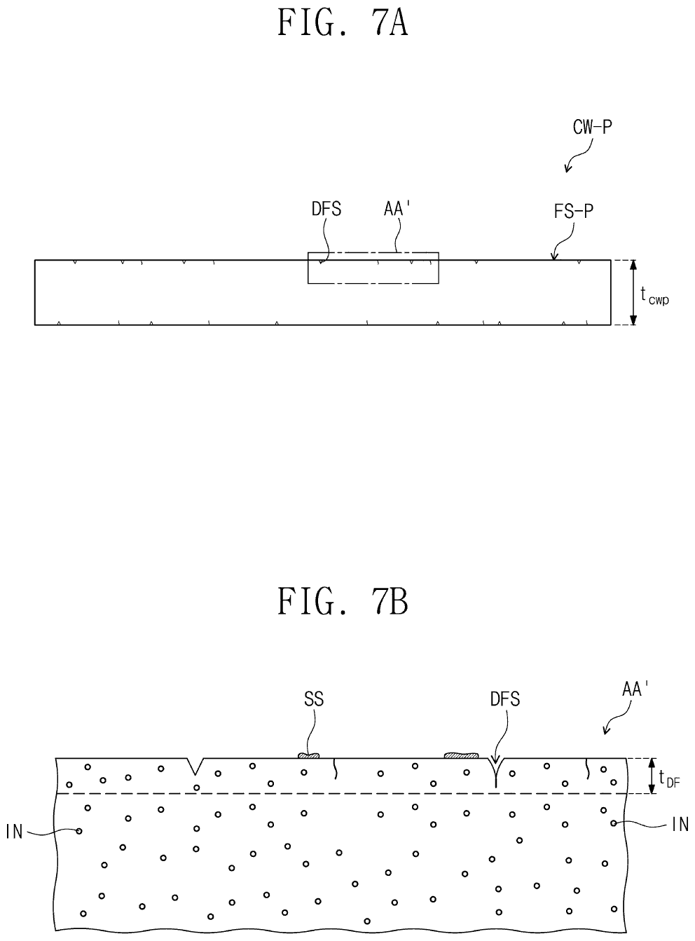

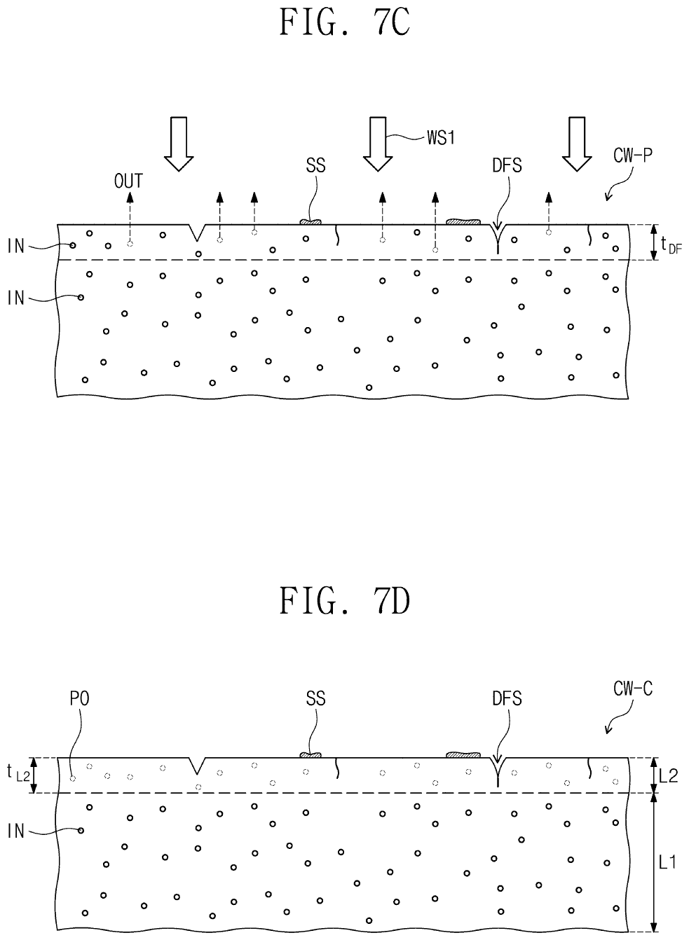

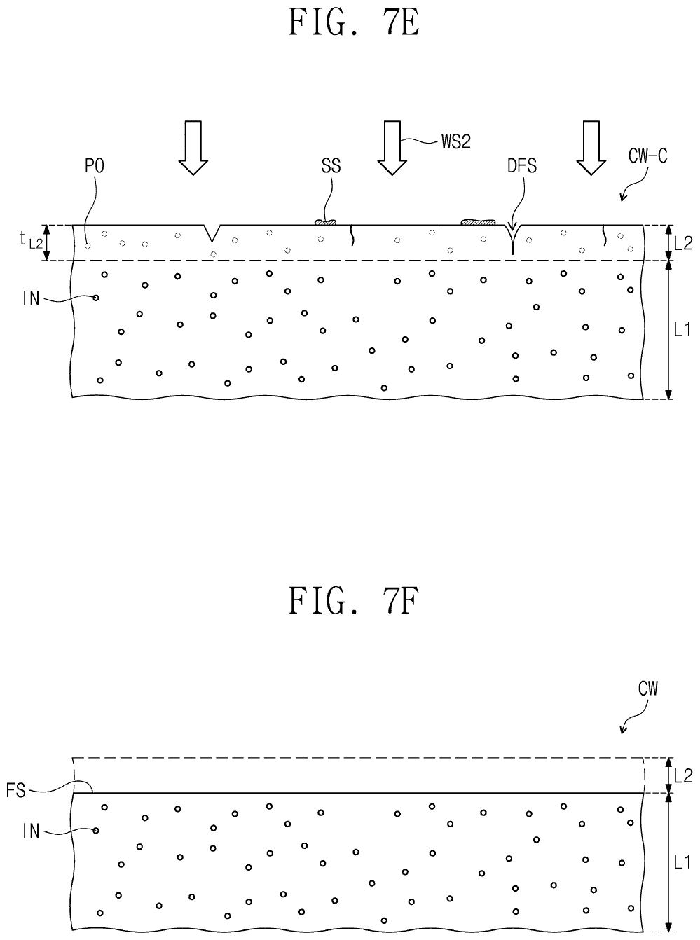

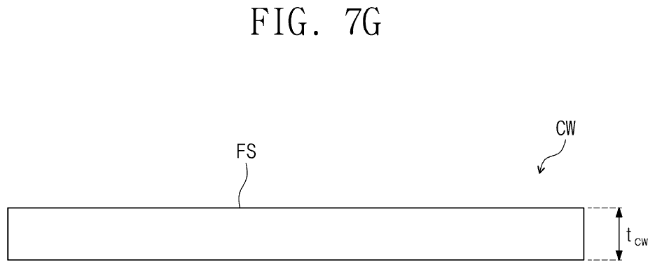

FIGS. 5 and 6 are flowcharts illustrating a method for manufacturing a window according to an embodiment of the inventive concept. FIGS. 7A to 7G are schematic cross-sectional views illustrating the method for manufacturing the window according to an embodiment of the inventive concept.

The method for manufacturing the window according to an embodiment may include a process (S100) of providing an initial window and a cleaning process (S300) of cleaning the provided initial window. In addition, the cleaning process (S300) may include acid cleaning process (S310) of cleaning the provided initial window by using acid and an alkali cleaning process (S330) of cleaning the acid-cleaned initial window by using alkali. The acid cleaning process (S310) and the alkali cleaning process (S330) may be sequentially performed.

The initial window CW-P may be provided as a window CW through the cleaning process (S300). While the cleaning process (S300) is performed, a portion of a surface FS-P of the initial window CW-P may be reduced, and thus, a second compressive stress value in the window CW may be reduced compared to a first compressive stress value of the initial window CW-P. Since defects DFS of the surface FS-P of the initial window CW-P are reduced through the cleaning process (S300), after the cleaning process (S300), the window WP may be improved in mechanical properties such as surface strength, impact resistance, and the like compared to those of the initial window CW-P.

In the method for manufacturing the window according to an embodiment, the process (S100) of providing the initial window may include a process (S110) of providing base glass and a base glass toughening process (S130) of toughening the base glass.

In the method for manufacturing the window according to an embodiment, the base glass provided in the process (S110) of providing the base glass may be manufactured through a float process. Also, the provided base glass may be manufactured through a down draw process or a fusion process. However, embodiments of the inventive concept are not limited thereto, and the provided base glass may be manufactured by various methods that are not illustrated in another embodiment.

The base glass provided in the process (S110) of providing the base glass may be provided as a cut status before the toughening process (S130) in an embodiment. However, embodiments of the inventive concept are not limited thereto. In another embodiment, the base glass may be provided in a size that does not match a size of a product to be finally applied and then be cut and processed to the final product application size after the window manufacturing process.

The base glass may be flat. Also, the base glass may be bent. For example, the base glass provided by being cut in consideration of the size of the finally applied product may be convexly or concavely bent with respect to a central portion thereof Alternatively, the base glass may include a bent portion at an outer portion thereof. However, embodiments of the inventive concept are not limited thereto, and the base glass may be provided in various shapes.

In an embodiment, the base glass provided in the process (S100) of providing the base glass may be lithium alumino-silicate (“LAS”)-based glass or sodium alumino-silicate (“NAS”)-based glass. For example, the base glass may include SiO₂, Al₂O₃, and Li₂O₃. Particularly, the base glass may include about 50 percent by weight (wt %) to about 80 wt % of SiO₂, about 10 wt % to about 30 wt % of Al₂O₃, and about 3 wt % to about 20 wt % of Li₂O₃. Also, in another embodiment, the base glass may include SiO₂, Al₂O₃, Li₂O₃, and Na₂O. The base glass may further include at least one of P₂O₅, K₂O, MgO, and CaO in addition to SiO₂, Al₂O₃, Li₂O₃, and Na₂O. However, embodiments of the inventive concept are not limited thereto, and the base glass used in an embodiment may be commercially used glass without limitation.

The base glass toughening process (S130) may be a process of chemically toughening the base glass by providing toughening molten salt to the base glass. That is, the base glass toughening process (S130) may be a process of immersing the base glass in the toughening molten salt to toughen a surface of the base glass through an ion exchange method. The toughening molten salt provided to the base glass may be one kind or two kinds or more of alkali ions.

The base glass toughening process (S130) may be performed by exchanging alkali metal ions having a relatively small ionic radius in the base glass surface with alkali metal ions having a larger ionic radius. For example, the surface toughening may be performed by exchanging ions such as Li⁺ or Na⁺ in the base glass surface with Na⁺ or K⁺ ions provided from the toughening molten salt, respectively (i.e., exchanging Li⁺ with Na⁺ and exchanging Na⁺ with K⁺. The window manufactured through the base glass toughening process (S130) may include a compressive stress area on the surface. The compressive stress area may be defined on at least one surface of the front and rear surfaces of the base glass.

The toughening molten salt provided in the base glass toughening process (S130) may be mixed salt or single salt. The mixed salt may be molten salt containing two or more kinds of ions selected from the group consisting of Li⁺, Na⁺, K⁺, Rb⁺, and Cs⁺. Also, the single salt may also be molten salt containing any one ion selected from the group consisting of Li⁺, Na⁺, K⁺, Rb⁺, and Cs⁺. For example, the toughening process in the method for manufacturing the window according to an embodiment may include molten salt of KNO₃ and NaNO₃ as the mixed salt, and molten salt of KNO₃ as the single salt.

The base glass toughening process (S130) may be performed at a temperature of about 350 degrees Celsius (° C.) to about 450° C. However, embodiments of the inventive concept are not limited thereto, and the process temperature in the toughening process (S130) may be adjusted according to the type of used toughening molten salt.

The base glass provided in the above-mentioned process (S110) of providing the base glass may be provided to the initial window CW-P by performing the base glass toughening process (S130).

FIG. 7A illustrates the process of providing the initial window. In addition, FIG. 7B is a cross-sectional view illustrating a portion of the initial window. FIG. 7B is an enlarged view of an area “AA” of FIG. 7A.

In the method for manufacturing the window according to an embodiment, the initial window CW-P represents the base glass after the toughening process (S130) is performed. The initial window CW-P may have a predetermined thickness t_{CWP}. The initial window CW-P that undergoes the toughening process (S130) may include alkali metal oxide such as Na₂O or K₂O. In this specification, for easy explanation, alkali metal ions IN are illustrated as circles as shown in FIGS. 7B to 7F.

The initial window CW-P formed through the base glass toughening process (S130) may include a compressive stress layer formed adjacent to the surface FS-P, and the initial window CW-P may have a first compressive stress value in an area adjacent to the surface FS-P.

The initial window CW-P may have a plurality of defects DFS generated in the surface FS-P. The defects DFS of the initial window CW-P may be scratches generated in the surface FS-P of the initial window CW-P or a portion recessed from the surface FS-P. The defects DFS may be formed due to collision with the outside or contact with the external environments while the initial window CW-P is formed or moves.

A foreign substance SS may be attached to the surface FS-P of the initial window CW-P. The foreign substance SS may include materials different from materials included in the initial window CW-P and may include organic materials and/or inorganic materials. The foreign substance SS may be attached while the initial window CW-P is formed or moves.

The roughness of the surface FS-P of the initial window CW-P may vary according to the number of defects DFS generated in the surface FS-P or shapes of the defects DFS. The failure strength of the initial window CW-P may be reduced by the defects DFS generated in the outer surface FS-P of the initial window CW-P. That is, the defects DFS may be a portion at which cracks occur, or cracks are easily transmitted when an external impact or the like is applied to the initial window CW-P, and thus the defects DFS may reduce the failure strength of the initial windows CW. As used herein, the failure strength of an object is a maximum stress the object may withstand without breaking.

In the cross-section, a depth t_{DF} of the defects DFS may be smaller than the thickness t_{CWP} of the initial window CW-P. For example, the depth t_{DF} of the defects DFS may range of about 0.2 micrometers (μm) to about 0.5 μm Compared to that the thickness t_{CWP} of the initial window CW-P may be about 300 μm or more. In an embodiment, the thickness t_{CWP} of the initial window CW-P may range of about 500 μm to about 800 μm.

The provided initial window CW-P is provided to the window CW through the cleaning process (S300). The cleaning process (S300) may include an acid cleaning process (S310) and an alkali cleaning process (S330). For easy explanation, FIGS. 7C to 7F illustrate an area corresponding to the area AA of FIG. 7B. FIGS. 7C and 7D illustrate cross-sectional views corresponding to the acid cleaning process (S310), and FIGS. 7E and 7F illustrate cross-sectional views corresponding to the alkali cleaning process (S330). FIG. 7G is a cross-sectional view of a window provided through the acid cleaning process (S310) and the alkali cleaning process (S330).

Referring to FIGS. 7C an 7D, the acid cleaning process (S310) may be a process of providing the initial window CW-P to an acidic environment. The acidic environment may mean an environment having a hydrogen exponent (hereinafter, referred to as a pH) index of less than 7, and may be provided in various forms such as liquid, gas, or solid in the condition that it is acid.

In the method for manufacturing the window according to an embodiment, the acid cleaning process (S310) may be performed by providing an acid cleaning solution WS1 to the initial window CW-P. The acid cleaning solution WS1 according to an embodiment of the inventive concept may be a strong acid having a pH2 or less. The acid cleaning solution WS1 may include at least one of a nitric acid (HNO₃), a sulfuric acid (H₂SO₄), and a hydrochloric acid (HCl). The pH index of the acid cleaning solution WS1 may be measured to about 2.5 or less at room temperature.

The acid cleaning solution WS1 may react with the initial window CW-P to form an intermediate layer L2 in the initial window CW-P. Thus, as illustrated in FIG. 7D, the initial window CW-P may be formed as an intermediate window CW-C divided into an intermediate layer L2 and a base layer L1 through the acid cleaning process (S310). The intermediate layer L2 may be a surface layer disposed on the base layer L1 and exposed to the outside. The intermediate layer L2 may be formed by surrounding a surface of the base layer L1.

The intermediate layer L2 may be a layer in which at least a portion of the alkali metal ions IN of the initial window CW-P are removed due to the reaction with the acid cleaning solution WS1. Here, the arrows with broken lead lines in FIG. 7C express the escape OUT of the alkali metal ions IN and a void PO may be defined in a position from which the alkali metal ions IN have escaped. Also, hydrogen ions provided from the acid cleaning solution WS1 may be disposed at the position from which the alkali metal ions IN are removed. The intermediate layer L2 of the intermediate window CW-C after the acid cleaning process (S310) is performed may have porous characteristics compared to the base layer L1. A density of the intermediate layer L2 may be less than that of the base layer L1.

As the alkali metal ions IN are removed in the acid cleaning process (S310), a silicon content ratio in the intermediate layer L2 may be greater than that in the base layer L1. The ratio of the silicon content to the alkali metal ions in the intermediate layer L2 may be greater than that the ratio of the silicon content to the alkali metal in the base layer L1. That is, the intermediate layer L2 may be a Si-rich layer compared to the base layer L1.

The ratio of the silicon content to the alkali metal in the base layer L1 may substantially correspond to the ratio of the silicon content to the alkali metal ion ratio in the initial window CW-P. Thus, in the acid cleaning process (S310), only the density of the intermediate layer L2 adjacent to the surface FS-P and having the defects DFS may be reduced to effectively remove the portion in which the detects DFS are generated.

A thickness t_{L2} of the intermediate layer L2 may be equal to or greater than a depth t_{DF} of the defects DFS illustrated in at least FIG. 7B. The thickness t_{L2} of the intermediate layer L2 may be about 0.2 μm to about 0.5 μm. Thereafter, the alkali cleaning process (S330) may be performed to remove the intermediate layer L2, thereby stably removing the defects DFS.

FIGS. 7E to 7G illustrate a process of manufacturing the window CW through the alkali cleaning process (S330). The alkali cleaning process (S330) may be a process of providing the intermediate window CW-C to an alkaline environment. The alkaline environment may mean an environment having a pH of more than 7, and may be provided in various forms such as liquid, gas, or solid in the condition that it has alkaline.

In the method for manufacturing the window according to an embodiment, the alkali cleaning process (S330) may be performed by providing an alkali cleaning solution WS2 to the intermediate window CW-C. The alkali cleaning solution WS2 according to an embodiment of the inventive concept may be a strong base of pH13 or more. The alkali cleaning solution WS2 may include sodium hydroxide (NaOH) or potassium hydroxide (KOH).

The alkali cleaning solution WS2 may react with the intermediate window CW-C to remove the intermediate layer L2 from the intermediate window CW-C. The intermediate layer L2 formed in the acid cleaning process (S310) may be finally removed in the alkali cleaning process (S330) to form the window CW in which the defects DFS are removed from the surface FS-P. That is, the defects DFS or the foreign substance SS existing in the initial window CW-P may be removed from the base layer L1 together with the intermediate layer L2.

Thus, the window CW may have the surface FS in which the defects DFS or the foreign substance SS do not remain. The surface FS of the window CW may substantially correspond to the surface of the base layer L1. The surface roughness of the window CW may be in a range of about 0.2 nanometers (nm) to about 3 nm. The surface roughness of the window CW may be less than that of the initial window CW-P or the intermediate window CW-C.

The window CW finally provided through the acid cleaning process (S310) and the alkali cleaning process (S330) has a predetermined thickness t_{CW}. The thickness t_{CW} of the window CW may be less than the thickness t_{CWP} of the initial window CW-P. The thickness t_{CW} of the window CW may correspond to the thickness of the base layer L1 in the intermediate window CW-C.

A cleaning amount in the method for manufacturing the window according to an embodiment corresponds to a weight of a portion adjacent to the surface FS-P of the initial window CW-P, which is removed in the cleaning process (S300). The cleaning amount may be measured as a removal amount per unit area, and the unit of the cleaning amount in this specification is expressed as milligrams per square centimeter, “mg/cm²”.

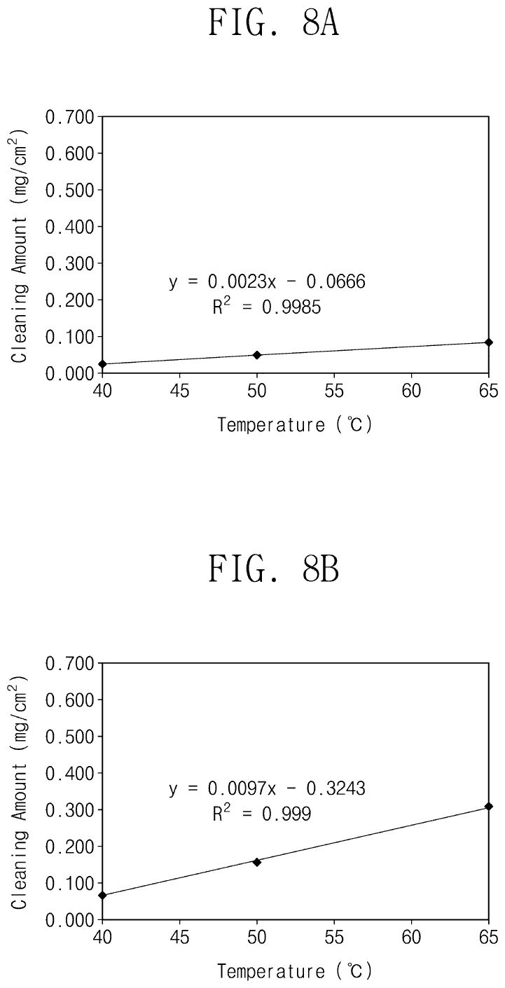

FIGS. 8A and 8B are graphs illustrating a variation in a cleaning amount depending on a process temperature in the acid cleaning process. FIG. 8A illustrates a cleaning amount in the acid cleaning process (S310), and FIG. 8B illustrates a cleaning amount in the alkali cleaning process (S330). The cleaning amount in the alkali cleaning process (S330) illustrated in FIG. 8B means a cleaning amount when the alkali cleaning process (S330) is sequentially performed after the acid cleaning process (S310) at the same temperature. In FIGS. 8A and 8B, a process holding time of the cleaning process is performed for about 10 minutes.

In FIGS. 8A and 8B, “y” axis corresponds to a cleaning amount, “x” axis is a process temperature, and “R²” corresponds to a coefficient of determination. Referring to FIGS. 8A and 8B, it may be seen that the cleaning amount in each cleaning process increases in proportion to a temperature in the cleaning process, and that a cleaning amount in the alkali cleaning process is greater than that the cleaning amount in the acid cleaning process.

In the method for manufacturing the window according to an embodiment, the total cleaning amount may be expressed as the sum of a first cleaning amount in the acid cleaning process and a second cleaning amount in the alkali cleaning process. The first cleaning amount cleaned under the conditions of the method for manufacturing the window according to an embodiment ranges of about 30 wt % to about 40 wt % based on the total weight of the final cleaning amount, and the second cleaning amount ranges of about 60 wt % to about 70 wt % based on the total weight of the final cleaning amount. For example, about ⅓ of the total cleaning amount may be a cleaning amount in the acid cleaning process, and about ⅔ of the total cleaning amount may be a cleaning amount in the alkali cleaning process.

The window CW finally provided according to the method for manufacturing the window according to an embodiment may include a compressive stress layer adjacent to the surface FS, and the window CW may represent a second compressive stress value in an area adjacent to the surface FS.

In the method for manufacturing the window according to an embodiment, a difference between the first compressive stress value of the initial window CW-P and the second compressive stress value of the window CW after the cleaning process may satisfy Equations 1 and 2 below.

ΔCS(MPa)=δ·t(min)+θ (1)

ΔCS(MPa)=α·T(° C.)+β (2)

In Equations 1 and 2, ΔCS is an absolute value of the difference between the first compressive stress value and the second compressive stress value, T is a temperature in the acid cleaning process, and t is a holding time in the acid cleaning process. ΔCS may correspond to |first compressive stress value−second compressive stress value|.

In Equations 1 and 2, words in parentheses represent following units of corresponding parameters: a unit of the difference in the compressive stress value of ΔCS is megapascals (MPa), and a unit of the temperature T in the acid cleaning process is degrees Celsius (° C.), and a unit of the process time t in the acid cleaning process is minutes.

Hereinafter, with respect to ΔCS, T, and t used in the relational expression described in this specification, the same contents as those defined in the above-described Equations 1 and 2 are applied. In addition, in this specification, the absolute value of the difference between the first compressive stress value and the second compressive stress value has the same meaning as the difference between the first compressive stress value and the second compressive stress value and also is used as the same as a variation in the compressive stress value. That is, the difference between the first compressive stress value and the second compressive stress value and the variation in the compressive stress value may be equally represented by ΔCS.

Equation 1 is a linear relational expression showing a relationship between the process holding time t in the acid cleaning process and the variation ΔCS in the compressive stress value. In Equation 1, 0<δ≤10 and −300≤θ<0. Equation 2 is a linear relational expression showing a relationship between the process temperature T in the acid cleaning process and the variation ΔCS in the compressive stress. In Equation 2, 0<α≤10 and 0<β≤50.

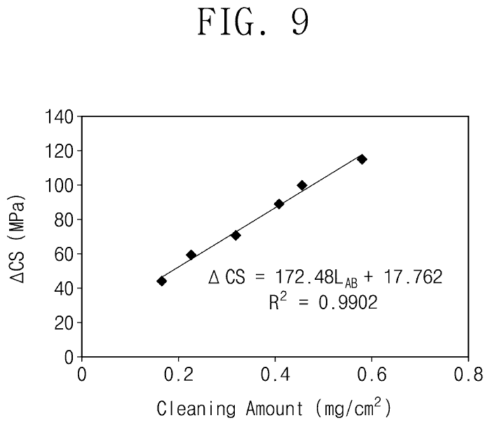

FIG. 9 illustrates a relationship between the cleaning amount in the window manufactured by the method for manufacturing the window according to an embodiment and the compressive stress value of the window. In FIG. 9, “ΔCS” is a variation in the compressive stress value, “L_{AB}” is a cleaning amount, and “R²” corresponds to a coefficient of determination. The variation ΔCS in the compressive stress value corresponds to a difference between the compressive stress value in the area adjacent to the surface FS-P of the initial window CW-P and the compressive stress value in the area adjacent to the surface FS of the window CW in the method for manufacturing the window according to an embodiment, which is described with reference to FIGS. 7A to 7G. In the method for manufacturing the window according to an embodiment of the inventive concept, the variation ΔCS in the compressive stress value and the cleaning amount L_{AB} satisfy the following relational expression. In the following Equation A, G is a stress reduction coefficient and may satisfy the following relational expression: 0<G≤1000. Z is a constant value and may satisfy the following relational expression: −50<Z≤50.

ΔCS=G·L_{AB}+Z (A)

In FIG. 9, a relationship between the cleaning amount L_{AB} and the variation in the compressive stress value ΔCS is measured and shown, and it is seen that the window manufactured by the method for manufacturing the window according to an embodiment satisfies the above Equation A through the derived relational expression: ΔCS=172.48·L_{AB}+1.762, for example. That is, in the method for manufacturing the window according to an embodiment, it is seen that the variation in the compressive stress value ΔCS is linearly proportional to the cleaning amount L_{AB}. Therefore, the cleaning amount L_{AB} in the cleaning process of the method for manufacturing the window according to an embodiment may be adjusted to finally control the compressive stress value ΔCS of the window.

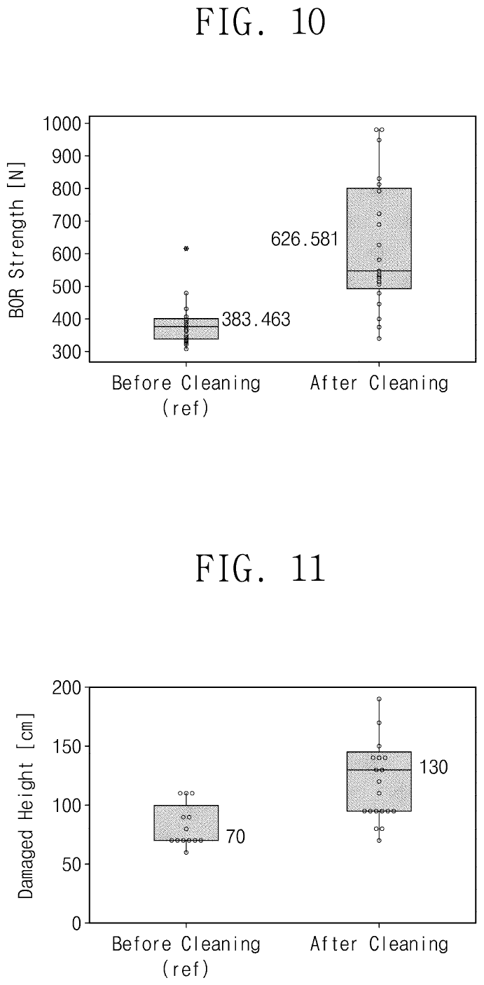

The method for manufacturing the window according to an embodiment may have improved strength characteristics. FIGS. 10 and 11 illustrate a change in strength characteristics of the window before and after the cleaning process, respectively.

FIGS. 10 and 11, “before the cleaning (ref)” represents results for the initial window CW-P, and “after the cleaning” represents results for the window CW that proceeds to the cleaning process (S300).

In FIG. 10, BOR strength is compared and shown. The BOR strength is evaluated by a ball on ring (“BOR”) test method. The initial window CW-P and the window CW, which are test objects, are disposed on a round ring (having a diameter of about 30 mm, wherein a maximum outer diameter is about 35 mm, and a maximum inner diameter is about 25 mm), and then, a test probe having a spherical shape with a diameter of about 10 mm contacts each of the initial window CW-P and the window CW, which are test objects, to measure strength when the initial window or the window is damaged while applying a load. In the measurement, the strength when being damaged is expressed as BOR strength N.

Referring to the results of FIG. 10, an average BOR strength before the cleaning corresponds to about 383.5 N, and an average BOR strength after the cleaning is measured to be about 626.6 N. Thus, it may be confirmed that the strength characteristics of the window are improved by the cleaning process. The window used for the evaluation in FIG. 10 is cleaned by using acid at about 65° C. for about 10 minutes and also cleaned by using alkali at about 65° C. for about 10 minutes.

The BOR strength of the window manufactured by the method for manufacturing the window manufacturing according to an embodiment may be about 500 N or more. For example, the BOR strength of the window manufactured by the method for manufacturing the window manufacturing according to an embodiment may range of about 500 N to about 1,000 N.

FIG. 11 illustrates results of a drop test. The measurement for the results in FIG. 11 is performed using an electronic apparatus model (mock-up sample) including the window. In FIG. 11, “before the cleaning (ref)” represents results for the electronic apparatus model including the initial window CW-P that does not undergo the cleaning process, and “after the cleaning” represents results for the electronic apparatus model including the window CW. The window CW used for the evaluation in FIG. 11 is cleaned by using acid at about 65° C. for about 10 minutes and also cleaned by using alkali at about 65° C. for about 10 minutes.

The drop test is performed by allowing an electronic apparatus model sample including the window to drop onto a granite substrate so as to check whether the electronic apparatus model sample is damaged. The measurement values illustrated in FIG. 11 indicate a maximum drop height at which the window is damaged (i.e., damaged height) when the electronic apparatus model sample falls. The drop height increases from about 60 centimeters (cm) as a starting height by about 10 cm.

Referring to the results of FIG. 11, the average drop height before the cleaning is about 70 cm, and the average drop height after the cleaning is about 130 cm. Thus, it is confirmed that the strength measured by the drop test is improved by about 1.8 times in the window on which the cleaning process is performed. That is, it is confirmed that the method for manufacturing the window according to an embodiment provides a window having improved impact resistance by performing the cleaning process including the acid cleaning process and the alkali cleaning process.

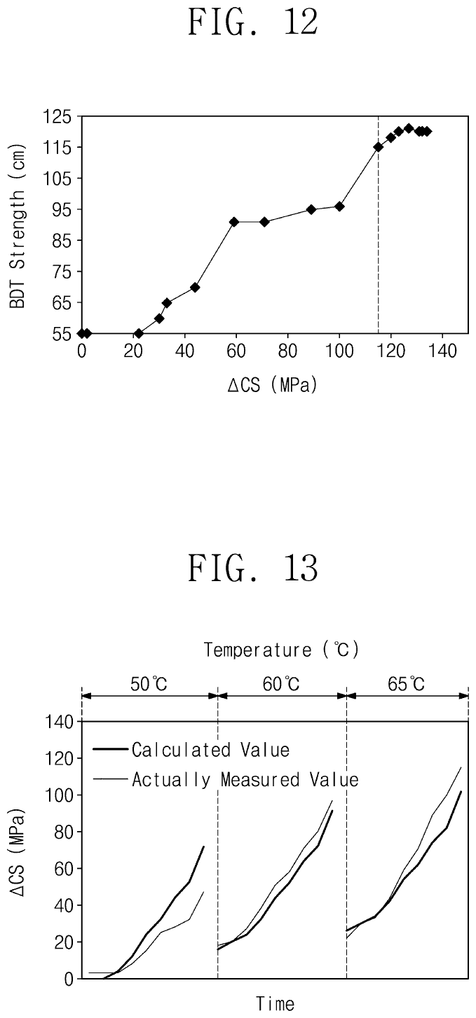

FIG. 12 is a graph illustrating impact resistance strength according to a vibration in the compressive stress value. In FIG. 12, the BDT strength (cm) of “y” axis corresponds to evaluation results of the ball drop test which is an impact resistance evaluation method. The ball drop test is evaluated by measuring a height at which the window is damaged when a steel ball having a weight of about 150 grams (g) drops onto the window.

Referring to the results of FIG. 12, it is seen that the BDT strength is improved according to an increase of the variation in the compressive stress value ΔCS of “x” axis measured in megapascals (MPa), but a degree of increase of the BDT strength is low when the variation ACS in the compressive stress value is greater than about 120. It is confirmed that when the variation ΔCS is about 120 or less, the BDT strength value increases approximately linearly with the increase of the variation ΔCS, and when the variation ACS is greater than 120, a value of the variation ΔCS is saturated.

That is, the BDT strength of the window may be improved by changing the compressive stress value through the cleaning process in the method for manufacturing the window according to an embodiment. Particularly, it is confirmed that when the variation ΔCS is about 120 or less, a degree of improvement of the impact resistance according to the cleaning process is high.

As described above, the difference ΔCS between the first compressive stress value of the initial window and the second compressive stress value of the window after the cleaning process satisfies the relational expressions of Equations 1 and 2. Particularly, the difference ΔCS is linearly proportional to each of the temperature T in the acid cleaning process and the process holding time t in the acid cleaning process, and thus, the temperature T and the time t in the acid cleaning process may be optimized to obtain a final compressive stress value required for the window. That is, the temperature T and the time t in the acid cleaning process may be optimized to manufacture the window having the required impact resistance and failure strength.

In the method for manufacturing the window according to an embodiment, the cleaning process including the acid cleaning process and the alkali cleaning process may be performed to provide the window having the improved impact resistance and failure strength. The final compressive stress value of the window may be predicted using the relational expression between the variation in the compressive stress value ΔCS (i.e., absolute value of the difference between the first compressive stress value and the second compressive stress value), the process temperature T and process time t in the acid cleaning process, which are proposed in the inventive concept. Also, the cleaning conditions may be easily proposed and controlled to obtain the strength characteristics, which are required for the finally provided window by using the relational expression between the variation in the compressive stress value ΔCS, the process temperature T and process time t in the acid cleaning process, which are proposed in the inventive concept.

As described above, ΔCS that is the variation in the compressive stress value satisfies the relational expressions of Equations 1 and 2. In addition, ΔCS that is the variation in the compressive stress value is proportional to each of the temperature T in the acid cleaning process and the holding time t in the acid cleaning process. Thus, the temperature T in the acid cleaning process or the holding time tin the acid cleaning process may be adjusted using the relational expressions of Equations 1 and 2 proposed in the inventive concept to control ΔCS that is the variation in the compressive stress value.

Δ CS that is the variation in the compressive stress may be proportional to a combination of the temperature T in the acid cleaning process and the holding time t in the acid cleaning process. That is, ΔCS that is the variation in the compressive stress value may be expressed by a linear relational expression in which both the temperature T in the acid cleaning process and the holding time t in the acid cleaning process are provided as variables.

ΔCS that is the variation in the compressive stress, the temperature T in the acid cleaning process, and the holding time t in the acid cleaning process may satisfy the following Equation 3.

ΔCS(MPa)=ν·T(° C.)+ω·t(min)+γ (3)

In Equation 3, 0<ν≤10, 0<ω≤20, −150≤γ≤−50, and words in parentheses represent following units of corresponding parameters: a unit of the difference in the compressive stress value of ΔCS is megapascals (MPa), and a unit of the temperature T in the acid cleaning process is degrees Celsius (° C.), and a unit of the process time t in the acid cleaning process is minutes.

For example, the difference between the first compression stress value and the second compression stress value may satisfy the following Equation 3-1.

ΔCS(MPa)=4T(° C.)+2t(min)+γ. [Equation 3-1]

In Equation 3-1, a constant γ satisfies the following relational expression: −150≤γ≤−50.

Hereinafter, FIGS. 13 to 18 are graphs illustrating the difference between the first compressive stress value and the second compressive stress value according to the conditions of the cleaning process in the method for manufacturing the window according to an embodiment. FIGS. 13 to 18 illustrate the difference in the compressive stress value according to the process conditions in the acid cleaning process of the above-described cleaning process. Here, a sulfuric acid solution is used as the acid cleaning solution as an example. However, the relational expressions proposed in an embodiment of the inventive concept, which are described below with reference to FIGS. 13 to 18, are not limited to the case in which the sulfuric acid solution is used, and may be equally applied when a strong acid solution is used as the acid cleaning solution in another embodiment.

FIG. 13 is a graph illustrating the variation in the compressive stress value of y axis measured in megapascals according to the increase in the acid cleaning time of x axis measured in minutes at each acid cleaning temperature. In FIG. 13, “an actually measured value” represents a value obtained by measuring a variation in a compressive stress value at a corresponding process temperature and process time, and “a calculated value” is expressed by a graph of results of values calculated by inputting the process temperature and process time into the following Equation 3-1a.

ΔCS(MPa)=2T(° C.)+4t(min)−108 (3-1a)

In FIG. 13, the actually measured value and calculated value are measured and calculated, respectively, under conditions of acid cleaning temperatures of about 50° C., about 60° C., and about 65° C. and a process holding time of about 1 minute to about 20 minutes.

Referring to FIG. 13, it is seen that the values calculated from the relational expressions of Equation 3-1a proposed in the inventive concept under the conditions of the acid cleaning temperature of about 50° C. to about to 65° C. and the process holding time of about 1 minute to about 20 minutes are similar to the actually measured values. That is, the relational expressions between the difference ΔCS between the first compressive stress value and the second compressive stress value, the temperature T in the acid cleaning process and the process holding time t in the acid cleaning process, which are proposed in the inventive concept, may be used to predict the actual cleaning process.

In the method for manufacturing the window according to an embodiment, which is described with reference to FIGS. 5 to 7G, the process temperature T of the acid cleaning process (S310) may range of about 40° C. to about 70° C. The reactivity between the acid cleaning solution WS1 and the initial window CW-P may decrease at a temperature of less than about 40° C., and thus, the cleaning process may not proceed smoothly. In addition, the organic material contained in the acid cleaning solution WS1 may be vaporized as fume at a temperature of about 70° C. or more, and thus, there is a limitation in stability of the cleaning process.

In addition, the process holding time t in the acid cleaning process (S310) may range of about 1 minute (min) to about 20 minutes (min). FIG. 14A illustrates the variation ΔCS in the compressive stress according to the process holding time t in the acid cleaning process (S310). FIG. 14A illustrates the variation ΔCS in the compressive stress value of y axis measured in megapascals as the cleaning time t of x axis measured in minutes elapses at an acid cleaning temperature of about 65° C. Referring to FIG. 14A, it may be confirmed that the variation ACS in the compressive stress value increases as the process holding time t increases.

The cleaning time of about 1 minute corresponds to the minimum cleaning time at which minimal cleaning is enabled. In addition, when the acid cleaning process is maintained for more than about 20 minutes, an effect of improving the strength of the window as the cleaning time does not increase. That is, referring to FIG. 14A, compared to the increase of the variation ΔCS in the compressive stress value as the cleaning time elapses up to about 20 minutes, the variation ΔCS in the compressive stress value for the cleaning time exceeding about 20 minutes is not large, and when considering process economy, the acid cleaning process may be performed for the cleaning time of about 20 minutes or less.

In addition, when the acid cleaning process is performed for more than about 20 minutes, the ΔCS value increases to about 120 MPa or more. Thus, when considering the results of FIG. 12, an effect of improving the impact strength due to the increase of the ΔCS value is also insignificant. As a result, the process time t in the acid cleaning process is suitably in the range of about 1 minute to about 20 minutes.

FIG. 14B is a graph illustrating results obtained by measuring the value of the variation ΔCS (y axis) in the compressive stress value according to the process holding time t (x axis) in the acid cleaning process under specific temperature conditions and illustrates a relational expression according to the obtained results. FIG. 14B illustrates values obtained by measuring the difference ΔCS in the compressive stress value according to the acid cleaning process time t in a state in which the process temperatures T in the acid cleaning process (S310) are held to about 50° C., about 60° C., and about 65° C., respectively and also illustrates a relational expression that is derived according to the obtained values. The acid cleaning process time t is set to about 1 minute to about 20 minutes.

The graph of the measured value illustrated in FIG. 14B may satisfy the relational expression of Equation 1 described above. That is, it may be confirmed that the cleaning holding time t and the variation ΔCS in the compressive stress value in the acid cleaning process under the same process temperature T condition have a linear relational expression between the process holding time t and the variation ΔCS in the compressive stress value in the acid cleaning process, which are derived from the measured results of FIG. 14A.

For example, the process holding time t and the variation ΔCS in the compressive stress value at the process temperature of about 50° C. may have a relational expression of the following Equation 1-a. Equation 1-a corresponds to a case in which 6 is 2.4, and 0 is 2.3 in Equation 1.

ΔCS(MPa)=2.4t+2.3 (1-a)

In addition, the process holding times t and the variation ΔCS in the compressive stress values at the process temperature of about 60° C. and of about 50° C. may have relational expressions of the following Equations 1-b and 1-c, respectively.

[Equation 1-b]

(1-b)

[Equation 1-c]

ΔCS(MPa)=5t+19 (1-c)

Equation 1-b corresponds to a case in which δ is 4.3, and θ is 15 in Equation 1, and Equation 1-c corresponds to a case in which δ is 5, and θ is 19 in Equation 1. The above Equations 1-a to 1-c are relational expressions in which the process time t is satisfied in a range of about 1 minute to about 20 minutes.

It may be confirmed that the variation in the compressive stress value of the window manufactured by the method for manufacturing the window according to an embodiment is controlled by adjusting the process holding time in the acid cleaning process at a predetermined temperature through the above-described Equations 1 and 1-a to 1-c. That is, since the variation in the compressive stress value corresponds to the difference between the first compressive stress value of the initial window and the second compressive stress value of the window, the process temperature and the process holding time in the acid cleaning process may be controlled in consideration of the finally required compressive stress value of the window to perform the cleaning process.

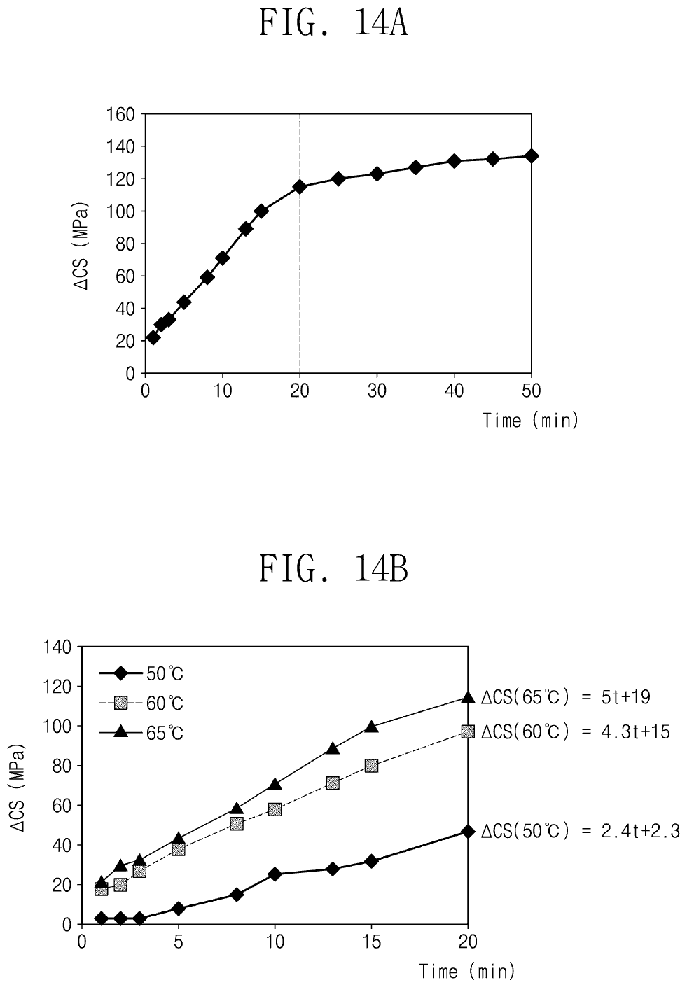

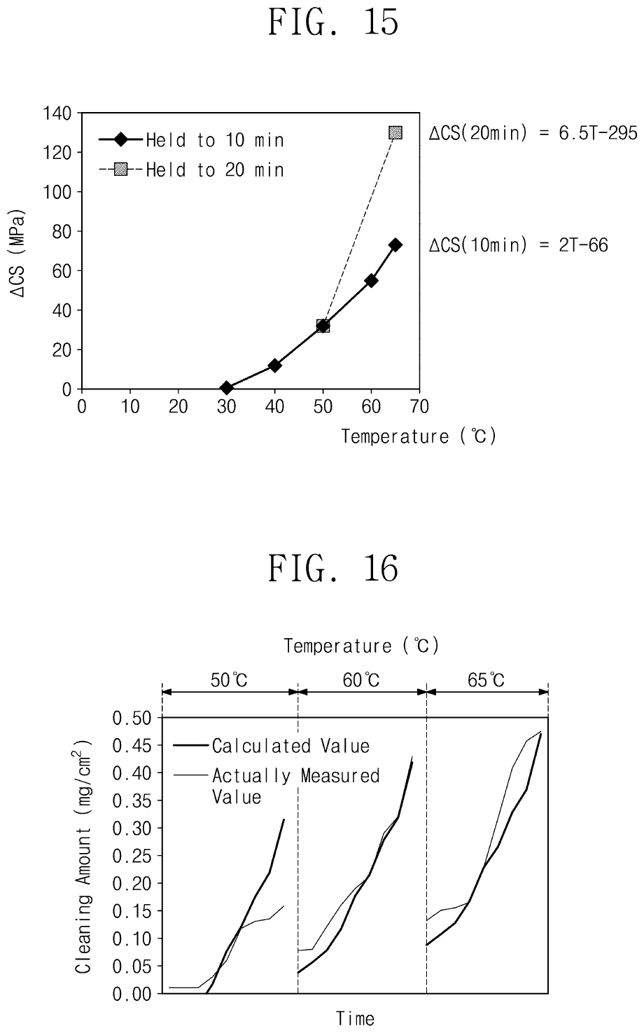

FIG. 15 is a graph illustrating results obtained by holding the process holding time t in the acid cleaning process (S310) and measuring the variation ACS (y axis) in the compressive stress value according to the change in the process temperature T (x axis) in the method for manufacturing the window according to an embodiment and also illustrates a relational expression according to the obtained results. FIG. 15 illustrates values obtained by measuring the difference in the compressive stress value according to the acid cleaning process temperature T in a state in which the process holding time t in the acid cleaning process is held to about 10 minutes and about 20 minutes and also illustrates a relational expression according to the obtained values. The measurement results illustrated in FIG. 15 are results measured at the process temperature ranging of about 30° C. to about 70° C. in the acid cleaning process.

The graph of the measured value illustrated in FIG. 15 may satisfy the relational expression of Equation 2 described above. That is, it may be confirmed that the acid cleaning process temperature T and the variation ΔCS in the compressive stress value at the same process holding time t has a substantially linear relational expression from the measured values of the process temperature in the acid cleaning process and the variation in the compressive stress value, which are derived from the measured results of FIG. 15.

For example, the process temperature T and the variation ΔCS in the compressive stress value for the process holding time of about 10 minutes may have a relational expression of the following Equation 2-a.

ΔCS(MPa)=2T−66 (2-a)

In addition, the process temperature T and the variation ΔCS in the compressive stress value for the process holding time of about 20 minutes may have a relational expression of the following Equation 2-b.

ΔCS(MPa)=6.5T−295 (2-b)

Equation 2-a corresponds to a case in which α is 2, and β is −66 in Equation 2, and Equation 2-b corresponds to a case in which α is 6.5, and β0 is −66 in Equation 2. The above Equations 2-a to 2-b are relational expressions in which the process temperature T is satisfied in a range of about 40° C. to about 70° C.

It may be confirmed that the variation in the compressive stress value of the window manufactured by the method for manufacturing the window according to an embodiment is controlled by adjusting the process time in the acid cleaning process for a predetermined process holding time through the above-described Equations 2 and 2-a to 2-b. That is, since the variation ACS in the compressive stress value corresponds to the difference between the first compressive stress value of the initial window and the second compressive stress value of the window, the process temperature T and the process holding time t in the acid cleaning process may be controlled in consideration of the finally required compressive stress value of the window to perform the cleaning process.

As described in FIG. 9, in the window manufactured by the method for manufacturing the window according to an embodiment, the difference between the compressive stress values before and after the cleaning process may be proportional to the cleaning amount in the window cleaning process. In the method for manufacturing the window according to an embodiment, which is described with reference to FIGS. 5 to 7G, the cleaning amount may be a removal amount per unit area of the surface FS-P of the initial window CW-P. For example, in an embodiment, the cleaning amount may be a removal amount of the intermediate layer L2 of the intermediate window CW-C. Also, the cleaning amount may correspond to a difference in weight between the initial window CW-P and the window CW.

In the method for manufacturing the window according to an embodiment, a cleaning amount L_{AB} and the process conditions in the acid cleaning process may satisfy the following Equations 4 and 5.

L_{AB}(mg/cm²)=δ′·t(min)+θ′ , [4]

L_{AB}(mg/cm²)=α′·T(° C.)+β′, [5]

In Equations 4 and 5, L_{AB} is a cleaning amount, T is a temperature in the acid cleaning process, and t is a holding time in the acid cleaning process. The cleaning amount L_{AB} corresponds to a weight that is removed while being processed from the initial window CW-P to the window CW. In Equations 4 and 5, words in parentheses represent following units of corresponding parameters: a unit of the cleaning amount L_{AB} is milligrams per square centimeter (mg/cm²), a unit of the temperature T in the acid cleaning process is degrees Celsius (° C.), and a unit of the process time t in the acid cleaning process is minutes (min).

Hereinafter, with respect to L_{AB} (mg/cm²), T (° C.), and t (min) used in the relational expression described in this specification, the same contents as those defined in the above-described Equations 4 and 5 are applied.

Equation 4 is a linear relational expression showing a relationship between the process holding time t in the acid cleaning process and the cleaning amount L_{AB}. In Equation 4, the following relational expression is satisfied: 0<67 ≤5 and −300≤θ′<0. Equation 5 is a linear relational expression showing a relationship between the process temperature T in the acid cleaning process and the cleaning amount L_{AB}. In Equation 5, the following relational expression is satisfied: 0<α′≤0.05 and 0<β′≤0.5.

The cleaning amount L_{AB} is proportional to each of the temperature T in the acid cleaning process and the holding time t in the acid cleaning process. Thus, the temperature T in the acid cleaning process or the holding time t in the acid cleaning process may be adjusted using the relational expressions of Equations 4 and 5 proposed in the inventive concept to control the cleaning amount L_{AB}. In addition, the cleaning amount L_{AB} may be controlled using the proportional relational expression between the cleaning amount L_{AB} and the variation ΔCS in the compressive stress value to change a surface compressive stress value of the window CW, thereby improving the impact strength of the window.

The cleaning amount L_{AB} may be proportional to a combination of the temperature T in the acid cleaning process and the holding time t in the acid cleaning process. That is, the cleaning amount L_{AB} may be expressed by a linear relational expression in which both the temperature T in the acid cleaning process and the holding time t in the acid cleaning process are provided as variables.

The cleaning amount L_{AB}, the temperature T in the acid cleaning process, and the holding time t in the acid cleaning process may satisfy the following Equation 6.

L_{AB}(mg/cm²)=ν·T(° C.)+ω·t(min)+γ′, [Equation 6]

In FIG. 6, the following relational expression is satisfied: 0<ν′≤0.05, 0<ω′≤0.1, −50≤γ′<0

The cleaning amount L_{AB}, the temperature T in the acid cleaning process, and the holding time t in the acid cleaning process may satisfy the following Equation 6-1, for example.

L_{AB} (mg/cm²)=0.01T(° C.)+0.02t(min)+γ′ [6-1]

In Equation 6-1, a constant γ′ satisfies the following relational expression: −50≤γ′<0.

FIG. 16 is a graph illustrating the cleaning amount L_{AB} (y axis) according to the increase in the acid cleaning time t (x axis) at each acid cleaning temperature T. In FIG. 16, “an actually measured value” represents a value obtained by measuring a cleaning amount L_{AB} at a corresponding process temperature T and process time t, and “a calculated value” is expressed by a graph of results of values calculated by inputting the process temperature and process time into the following Equation 6-1a.

L_{AB}(mg/cm²)=0.01T(° C.)+0.02t(min)−0.583 (6-1a)

In FIG. 16, the actually measured value and calculated value are measured and calculated, respectively, under conditions of acid cleaning temperatures of about 50° C., about 60° C., and about 65° C. and a process holding time of about 1 minute to about 20 minutes.

Referring to FIG. 16, it is seen that the values calculated from the relational expressions of Equation 6-1a proposed in the inventive concept under the conditions of the acid cleaning temperature T of about 50° C. to about to 65° C. and the process holding time t of about 1 minute to about 20 minutes are similar to the actually measured values. That is, the relational expressions between the cleaning amount, the temperature in the acid cleaning process, and the process holding time in the acid cleaning process, which are proposed in the inventive concept, may be used to predict the actual cleaning process.

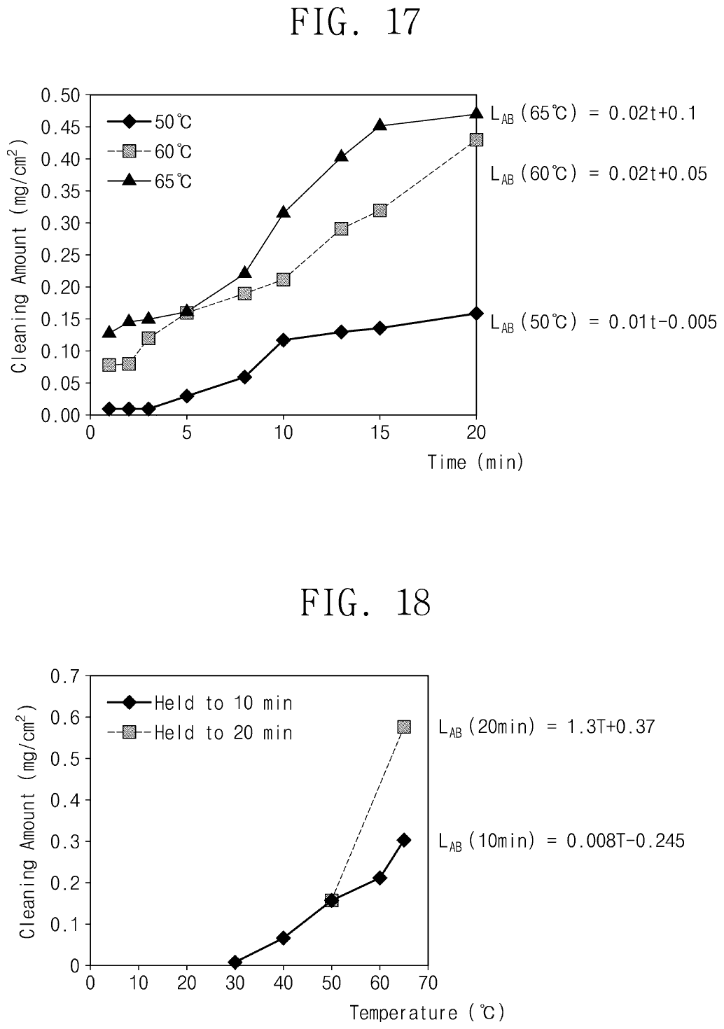

FIG. 17 is a graph illustrating results obtained by measuring the cleaning amount L_{AB} (y axis) according to the process holding time t (x axis) in the acid cleaning process under specific temperature T conditions and illustrates a relational expression according to the obtained results. FIG. 17 illustrates values obtained by measuring the cleaning amount L_{AB} according to the acid cleaning process time t in a state in which the process temperatures T in the acid cleaning process (S310) are held to about 50° C., about 60° C., and about 65° C., respectively and also illustrates a relational expression that is derived according to the obtained values. The acid cleaning process time t is set to about 1 minute to about 20 minutes.

The graph of the measured value illustrated in FIG. 17 may satisfy the relational expression of Equation 4 described above. That is, it may be confirmed that the cleaning holding time t and the cleaning amount L_{AB} in the acid cleaning process under the same process temperature T condition have a linear relational expression through the process holding time t and the cleaning amount L_{AB} in the acid cleaning process, which are derived from the measured results of FIG. 17.

In an embodiment, the process holding time t and the cleaning amount L_{AB} at the process temperature of about 50° C. may have a relational expression of the following Equation 4-a. Equation 4-a corresponds to a case in which δ′ is 0.01, and θ′ is −0.005 in Equation 4.

L_{AB}(mg/cm²)=0.01t−0.005 (4-a)

In addition, the process holding times t and the cleaning amount L_{AB} at the process temperature of about 60° C. and about 50° C. may have relational expressions of the following Equations 4-b and 4-c, respectively.

L_{AB}(mg/cm²)=0.02t+0.05 (4-b)

L_{AB}(mg/cm²)=0.02t+0.1 (4-c)

Equation 4-b corresponds to a case in which δ′ is 0.02, and θ′ is 0.05 in Equation 4, and Equation 4-c corresponds to a case in which δ′ is 0.02, and θ is 0.1 in Equation 4. The above Equations 4-a to 4-c are relational expressions in which the process time t is satisfied in a range of about 1 minute to about 20 minutes.

It may be confirmed that the cleaning amount of the window manufactured by the method for manufacturing the window according to an embodiment is controlled by adjusting the process holding time in the acid cleaning process at a predetermined temperature through the above-described Equations 4 and 4-a to 4-c. That is, since the cleaning amount corresponds to the difference between the first compressive stress value and the second compressive stress value, the process temperature and the process holding time in the acid cleaning process may be controlled in consideration of the finally required compressive stress value of the window to perform the cleaning process.

FIG. 18 is a graph illustrating results obtained by holding the process holding time t in the acid cleaning process (S310) and measuring the cleaning amount L_{AB} (y axis) according to the change in the process temperature T (x axis) in the method for manufacturing the window according to an embodiment and also illustrates a relational expression according to the obtained results. FIG. 18 illustrates values obtained by measuring the cleaning amount L_{AB} according to the acid cleaning process temperature T in a state in which the process holding time t in the acid cleaning process is held to about 10 minutes and about 20 minutes, respectively, and also illustrates a relational expression according to the obtained values. The measurement results illustrated in FIG. 18 are results measured at the process temperature ranging of about 30° C. to about 70° C. in the acid cleaning process.

The graph of the measured value illustrated in FIG. 18 may satisfy the relational expression of Equation 5 described above. That is, it may be confirmed that the acid cleaning process temperature T and the cleaning amount L_{AB} at the same process holding time t has a substantially linear relational expression from the measured values of the process temperature in the acid cleaning process and the cleaning amount L_{AB}, which are derived from the measured results of FIG. 18.

For example, the process temperature T and the cleaning amount L_{AB} for the process holding time of about 10 minutes may have a relational expression of the following Equation 5-a.

L_{AB}(mg/cm²)=0.008T-0.245 (5-a)

In addition, the process temperature T and the cleaning amount L_{AB} at the process holding time of about 20 minutes may have a relational expression of the following Equation 5-b.

L_{AB}(mg/cm²)=1.3T+0.37 (5-b)

Equation 5-a corresponds to the case where α′ is 0.008 and β′ is −0.245 in equation 5, and equation 5-b corresponds to the case where α′ is 1.3 and β′ is 0.37 in equation 5. The above Equations 5-a to 5-b are relational expressions in which the process temperature is satisfied in a range of about 40° C. to about 70° C.

It may be confirmed that the cleaning amount of the window manufactured by the method for manufacturing the window according to an embodiment is controlled by adjusting the process time in the acid cleaning process for a predetermined process holding time through the above-described Equations 5 and 5-a to 5-b. That is, since the cleaning amount corresponds to the difference between the first compressive stress value and the second compressive stress value, the process temperature and the process holding time in the acid cleaning process may be controlled in consideration of the finally required compressive stress value of the window to perform the cleaning process.

The method for manufacturing the window according to an embodiment may include the acid cleaning process and the alkali cleaning process, which are sequentially performed, and thus, the window having the improved strange characteristics and impact resistance may be provided. In addition, in an embodiment, the relational expression between the process temperature, the process holding time, and the cleaning amount in the cleaning process or the relational expression between the process temperature, the process holding time, and the variation in the compressive stress value in the cleaning process may be introduced to easily control the cleaning process for providing the window having the superior impact resistance and mechanical strength.

That is, in the method for manufacturing the window according to an embodiment, the acid cleaning process may be introduced, and thus, the acid cleaning process may be systematically managed in consideration of the physical properties required for the final window by using the relational expression with respect to the variation in the compressive stress value according to the process temperature and the process holding time, thereby improving the process economy.

The embodiment may provide the method for manufacturing the window, which is capable of controlling the cleaning process by proposing the relationship between the variations in compressive stress value depending on the process temperature and the process maintenance time in the acid cleaning process.

Embodiments may provide the method for manufacturing the window, which controls the cleaning process in consideration of the finally required physical properties of the window by proposing the relational expression between the process conditions and the cleaning amounts in the cleaning process.

It will be apparent to those skilled in the art that various modifications and variations can be made in the inventive concept. Thus, it is intended that the present disclosure covers the modifications and variations of this invention provided they come within the scope of the appended claims and their equivalents.

Hence, the real protective scope of the inventive concept shall be determined by the technical scope of the accompanying claims.

What is claimed is:

1. A method for manufacturing a window, the method comprising:
providing an initial window having a first compressive stress value; and
cleaning the initial window to provide a window having a second compressive stress value,
wherein the cleaning of the initial window comprises:
acid cleaning the initial window by using acid; and
alkali cleaning the initial window by using alkali after the acid cleaning,
wherein a difference between the first compressive stress value and the second compressive stress value satisfies following Equations 1 and 2:
ΔCS(MPa)=δ·t(min)+θ, [Equation 1]
ΔCS(MPa)=α·T(° C.)+β, [Equation 2]
wherein, in Equation 1, a following relational expression is satisfied: 0<γ≤10, and −300≤θ<0,
in Equation 2, a following relational expression is satisfied: 0<α≤10, and 0<β≤50,
in Equations 1 and 2, ΔCS is an absolute value of the difference between the first compressive stress value and the second compressive stress value, T is a temperature in the acid cleaning, and t is a holding time of the acid cleaning, and
in Equations 1 and 2, words in parentheses represent following units of corresponding parameters: a unit of ΔCS is megapascals (MPa), and a unit of T is degrees Celsius (° C.), and a unit of t is minutes (min).

2. The method of claim 1, wherein the temperature T in the acid cleaning of the Equation 2 ranges of about 40° C. to about 70° C.

3. The method of claim 1, wherein the holding time t in the acid cleaning of the Equation 1 ranges of about 1 minute to about 20 minutes.

4. The method of claim 1, wherein the difference between the first compressive stress value and the second compressive stress value satisfies following Equation 3:
ΔCS(MPa)=ν·T(° C.)+ω·t(min)+γ, [Equation 3]
wherein, in Equation 3, a following relational expression is satisfied: 0<ν≤10, 0<ω≤20, and −150≤γ≤−50.

5. The method of claim 4, wherein the difference between the first compressive stress value and the second compressive stress value satisfies following Equation 3-1:
ΔCS(MPa)=4T(° C.)+2t(min)+γ. [Equation 3-1]

6. The method of claim 1, wherein the difference between the first compressive stress value and the second compressive stress value is proportional to a cleaning amount in the acid cleaning, and
the cleaning amount is a removal amount per a unit area of the initial window, which is removed from a surface of the initial window.

7. The method of claim 6, wherein the cleaning amount satisfies following Equations 4 and 5:
L_{AB}(mg/cm²)=δ′·t(min)+θ′ , [Equation 4]
L_{AB}(mg/cm²)=α′·T(° C.)+β′, [Equation 5]
wherein, in Equation 4, a following relational expression is satisfied: 0<δ′≤5, and −300≤θ′<0,
in Equation 5, a following relational expression is satisfied: 0<α′≤0.05, and 0<β′≤0.5, and
in Equations 4 and 5, L_{AB} is a cleaning amount, and mg/cm²in parentheses represent a unit of L_{AB}: milligrams per square centimeter.

8. The method of claim 7, wherein the cleaning amount satisfies following Equation 6:
L_{AB}(mg/cm²)=ν·T(° C.)+ω·t(min)+γ′, [Equation 6]
wherein, in Equation 6, a following relational expression is satisfied: 0<ν′≤0.05, 0<ω′≤0.1, and −50≤γ′<0.

9. The method of claim 8, wherein the cleaning amount satisfies following Equation 6-1:
L_{AB} (mg/cm²)=0.01T(° C.)+0.02t(min)+γ′. [Equation 6-1]

10. The method of claim 6, wherein the cleaning amount is a sum of a first cleaning amount in the acid cleaning and a second cleaning amount in the alkali cleaning,
the first cleaning amount ranges of about 30 percent by weight (wt %) to about 40 wt % based on a total weight of the cleaning amount, and
the second cleaning amount ranges of about 60 wt % to about 70 wt % based on the total weight of the cleaning amount.

11. The method of claim 1, wherein the providing of the initial window comprises:
providing a base glass; and
toughening the provided base glass,
wherein the base glass comprises lithium alumino-silicate (LAS)-based glass or sodium alumino-silicate (NAS)-based glass.

12. The method of claim 11, wherein the toughening of the base glass comprises chemically toughening of the base glass by using toughening molten salt containing at least one of KNO3 KNO₃ or NaNO3 NaNO₃.

13. The method of claim 12, wherein the toughening of the base glass is performed at a temperature of about 350° C. to about 450° C.

14. The method of claim 1, wherein the acid cleaning comprises providing an acid cleaning solution containing at least one of a nitric acid (HNO₃), a sulfuric acid (H₂SO₄), or a hydrochloric acid (HCl).

15. The method of claim 1, wherein the alkali cleaning comprises providing an alkali cleaning solution containing at least one of sodium hydroxide (NaOH) or potassium hydroxide (KOH).

16. A method for manufacturing a window, the method comprising:
providing an initial window chemically toughened;
acid cleaning the initial window by using an acid cleaning solution to provide an intermediate window; and
alkali cleaning the intermediate window by using an alkali cleaning solution to provide a final window, wherein a first compressive stress value of the initial window and a second compressive stress value of the final window satisfy following Equations 1 and 2:
ΔCS(MPa)=δ·t(min)+θ, [Equation 1]
ΔCS(MPa)=α·T(° C.)+β, [Equation 2]
wherein, in Equations 1 and 2, ΔCS is an absolute value of a difference between the first compressive stress value and the second compressive stress value, and words in parentheses represent following units of corresponding parameters: a unit of ΔCS is megapascals (MPa), and a unit of T is degrees Celsius (° C.), and a unit of t is minutes (min),
in Equation 1, a following relational expression is satisfied: 0<δ≤10, −300≤θ<0, and 1 minute≤t≤20 minutes, and
in Equation 2, a following relational expression is satisfied: 0<α≤10, 0<β≤50, and 40° C.≤T≤70° C.

17. The method of claim 16, wherein the intermediate window comprises a void defined by eluting an alkali metal from the initial window.

18. The method of claim 17, wherein the intermediate window comprises:
a base layer in which a ratio of silicon content to the alkali metal is substantially the same as a ratio of the silicon content to the alkali metal in the initial window; and
an intermediate layer which is formed on a surface of the base layer and of which a ratio of the silicon content to the alkali metal ions is greater than the ratio of the silicon content to the alkali metal ions in the base layer.

19. The method of claim 18, wherein a ratio of the void in the intermediate layer is greater than a ratio of the void in the base layer.

20. The method of claim 18, wherein the initial window has a thickness of about 500 micrometers (μm) to about 800 μm, and the intermediate layer has a thickness of about 0.2 μm to about 0.5 μm.

21. The method of claim 18, wherein the final window is formed by removing the intermediate layer from the intermediate window.

22. The method of claim 16, wherein an absolute value of a difference between the first compressive stress value and the second compressive stress value is proportional to a cleaning amount, and the cleaning amount is a difference in weight between the initial window and the final window.

23. The method of claim 22, wherein the cleaning amount satisfies following Equations 4 and 5:
L_{AB}(mg/cm²)=δ′·t(min)+θ′ , [Equation 4]
L_{AB}(mg/cm²)=α′·T(° C.)+β′, [Equation 5]
wherein, in Equation 4, a following relational expression is satisfied: 0<δ′≤5, and −300≤θ′<0,
in Equation 5, a following relational expression is satisfied: 0<α′≤0.05, and 0<β′≤0.5, and
in Equations 4 and 5, L_{AB} is the cleaning amount, and mg/cm² in parentheses represent a unit of L_{AB}: milligrams per square centimeter.

24. The method of claim 16, wherein the difference between the first compressive stress value and the second compressive stress value satisfies following Equation 3-1:
ΔCS(MPa)=4T(° C.)+2t(min)+γ. [Equation 3-1]
